(19) United States
(12) Patent Application Publication
(10) Pub. No.: US 2013/0313815 A1
(43) Pub. Date: Nov. 28, 2013

(54) Scrapbook Having Transparent Photo Sleeves

(71) Applicant: Rebecca Senger, Helotes, TX (US)

(72) Inventor: Rebecca Senger, Helotes, TX (US)

(21) Appl. No.: 13/847,755

(22) Filed: Mar. 20, 2013

Related U.S. Application Data
(60) Provisional application No. 61/649,925, filed on May 22, 2012.

(51) Int. Cl. B42D 1/08

(52) U.S. Cl. CPC B42D 1/08
USPC 281/22

(57) ABSTRACT

A scrapbook for use in removing holding photographs and other personal artifacts includes a plurality of pages arranged in a stacked configuration, each page having opposed upper and lower surfaces and a side edge. The scrapbook includes a binding member coupled to respective side edges of the plurality of pages. A plurality of insert sleeves are coupled to selected surfaces of the plurality of pages, each insert sleeve having an open side configured to receive a photograph into an interior area.

### CROSS REFERENCE TO RELATED APPLICATION

This non-provisional patent application claims the benefit of provisional application Ser. No. 61/649,925 filed on May 22, 2012, titled Scrap Book Having Transparent Photo Sleeves.

### BACKGROUND OF THE INVENTION

This invention relates generally to the field of scrapbooking and, more particularly, to a scrapbook having sleeves that removably hold photographs and protect them from damage.

Scrapbooks and photo albums are both popular ways of organizing printed material related to one's experiences. Photo albums generally are limited by having a plurality of pages, each with several plastic sleeves into which photos may be inserted and removed. Scrapbooks, by contrast, typically provide large blank pages of heavy paper to which the user may directly affix any type of photograph, printed material, or other personal artifacts. Scrapbooks have become a very popular means of recording and storing a person's memories, accomplishments, or events of a family or community. Many people see the advantages of permanently storing personal artifacts in an attractive book, such artifacts including photographs, letters, notes, cards, crafts, gifts, awards, certificates, and the like.

Although a scrapbook offers improved versatility for materials other than just photographs, a photo album provides an advantageous means of removably mounting and storing photographic prints in a manner that will not damage them in the event a later re-use is desired. Therefore, it would be desirable to have a scrapbook that includes the advantageous structures of transparent sleeves that enable photographs to be removably held and displayed.

### SUMMARY OF THE INVENTION

Accordingly, the present invention pertains to a scrapbook, scrapbook page insert, or attachment for a scrapbook page wherein a plurality of plastic sleeves are provided for the protection and removable storage of printed material, for example photographic prints. The sleeves may be positioned in various configurations and intermingled with standard scrapbook contents.

Therefore, an object of this invention is to provide a scrapbook having transparent sleeves for removably storing and displaying photographic prints.

Another object of this invention is to provide a scrapbook, as aforesaid, that protects photographic prints from damage when inserted into respective sleeves.

Still another object of this invention is to provide a scrapbook, as aforesaid, having a plurality of pages on which one or more transparent sleeves may be permanently mounted.

Additional features and advantages of the invention will be set forth in the description which follow, and will be apparent from the description, or may be learned by practice of the invention. The forgoing general description and the following detailed description are exemplary and explanatory and are intended to provide further explanation of the invention.

### BRIEF DESCRIPTION OF THE DRAWINGS

FIG. 1 is a perspective view a scrapbook having transparent sleeves according to one embodiment of the present invention; and

FIG. 2 is a perspective view of a scrapbook having transparent sleeves according to another embodiment of the present invention.

FIG. 3 is an exploded view of the scrapbook as in FIG. 1;

FIG. 4a is a top view of a transparent sleeve removed from the scrapbook as in FIG. 1;

FIG. 4b is a sectional view taken along line 4b-4b of FIG. 4a; and

FIG. 4c is an isolated view on an enlarged scale taken from a portion of FIG. 4b.

### DETAILED DESCRIPTION OF THE INVENTION

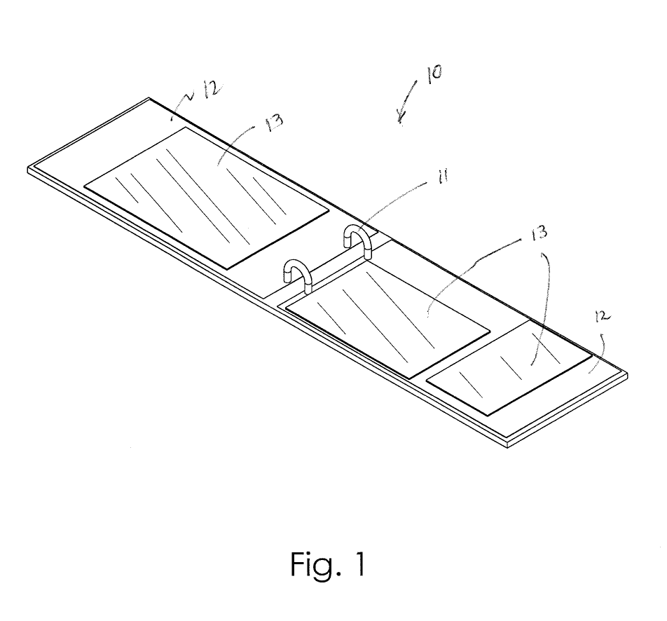

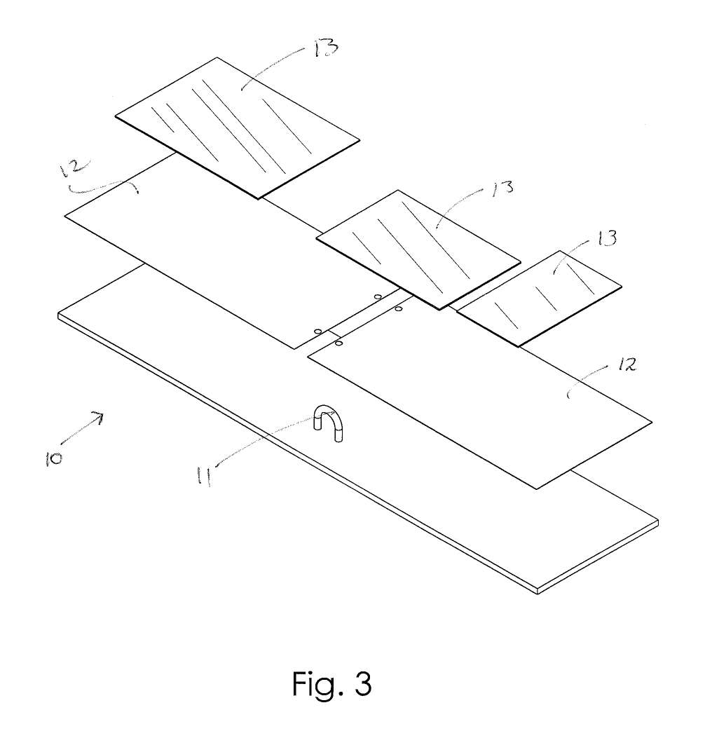

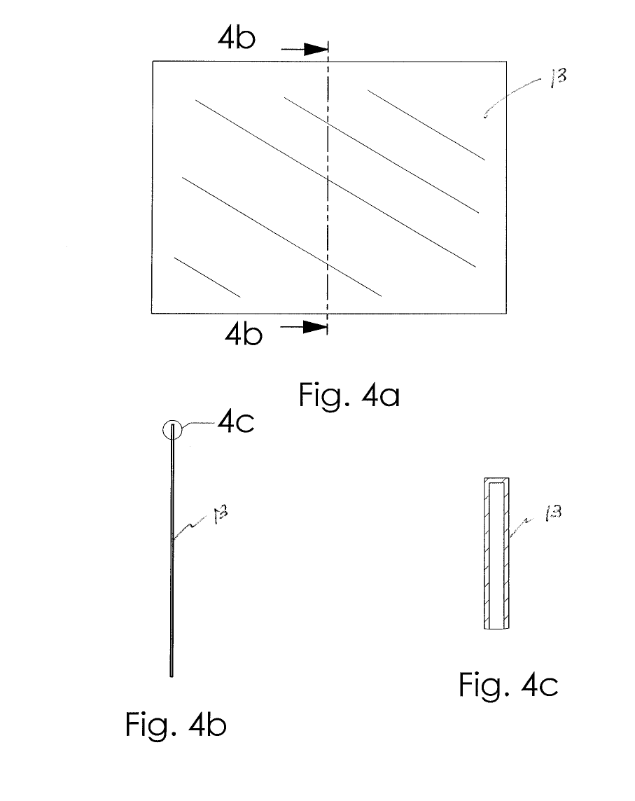

A scrapbook having one or more transparent sleeves according to the present invention will now be described in detail with reference to FIGS. 1 to 4c of the accompanying drawings.

FIG. 1 illustrates a first exemplary embodiment of the invention. In the first exemplary embodiment, a scrapbook 10 is provided having a plurality of pages 12 arranged in a stacked arrangement which are flexibly affixed to a binding member 11. Each page may include a side edge that may be secured by the binding member. The binding member 11 according to the first exemplary embodiment may include a two-ring binding system from which pages may be selectively added or removed although other embodiments may include a 3-ring binding system or other book-binding methods. The pages 12 are shown as rectangular although other configurations would also be suitable. Preferably, the pages are constructed of a heavy paper material although other materials may also work. Each page has a generally thin planar configuration having opposed upper and lower surfaces.

The scrapbook 10 may include a plurality of transparent insert sleeves 13 attached to the pages 12. Each page may include a plurality of insert sleeves 13 spaced apart from one another although some pages may include no sleeves at all. Respective sleeves may be attached to upper surfaces of respective pages or to both upper and lower surfaces. The insert sleeves 13 are shown as rectangular and mounted with their corners in alignment with those of the page 12; however these alignment details are not requirements. Portions of each page 12 that are not covered by a sleeve 13 may be used to support and retain scrapbook content for which a protective sleeve is not needed. Sleeves 13 may be mounted with adhesive either at the point of manufacture or by a user.

Referring still to the first exemplary embodiment shown in FIG. 1, the sleeves 13 themselves are preferably made of a transparent and flexible plastic film material. The sleeves 13 may be affixed to the page 12 using an adhesive or other fastening means. The sleeves 13 generally include at least one sheet of material that may be affixed to the page on three of its four sides and a second sheet overlaying the first. The first and second sheets of each insert sleeve 13 together define an open interior area and an open end through which a flat item of a complementary size or shape may be inserted. In other words, the sheets may be coupled together on 3 out of 4 sides. Where two or more sheets of material are provided to form the sleeve 13, the rearmost sheet may be secured directly to the page 13 throughout its entire area. In addition to being manufactured as a part of pages in a scrapbook or for insertion into a scrapbook the sleeves 13 may be manufactured and provided in conjunction with an adhesive such that the user may place the sleeves 13 at any desired location in the scrapbook.

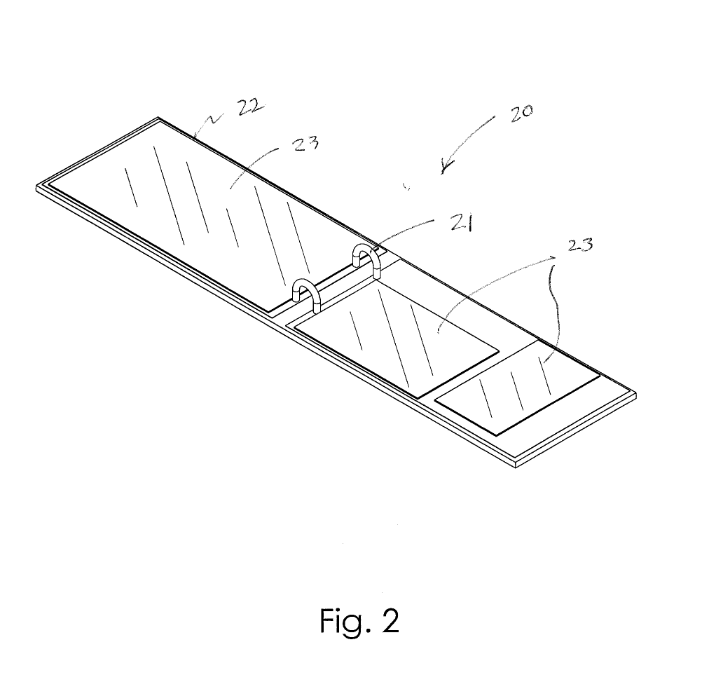

FIG. 2 shows a scrapbook 20 according to a second exemplary embodiment includes a binding 21 and a plurality of pages 22 having a construction substantially similar to the scrapbook 10 described above. The scrapbook 20 includes a plurality of insert sleeves 23, each sleeve 23 having a configuration that covers substantially all of the surface area of a respective page 22. Scrapbook material associated with the contents of the sleeve 23 may be omitted or placed on a facing page.

In use, treasured photographic prints may be selectively and removably preserved within respective sleeves 13 in the scrapbook 10 without damage or permanent attachment. It is understood that other articles of personal significance to a user may be affixed to respective surfaces of respective pages adjacent respective insert sleeves 13.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method and examples, but by all embodiments and methods within the scope and spirit of the invention.

1. A scrapbook for use in removably holding and displaying photographs and other personal artifacts, comprising:
a plurality of pages arranged in a stacked configuration, each page having opposed upper and lower surfaces and a side edge;
a binding member coupled to respective side edges of said plurality of pages; and
a plurality of insert sleeves coupled to selected pages of said plurality of pages.

2. The scrapbook as in claim 1, wherein each of said plurality of insert sleeves includes:
a first layer of plastic material having a generally rectangular configuration; and
a second layer of plastic material having a generally rectangular configuration and overlaying said first layer, said first and second layers being coupled on three of four side edges so as to define an interior area and an opening configured to receive a photograph into said interior area.

3. The scrapbook as in claim 2, wherein said first layer of a respective insert sleeve includes a bottom surface adhesively coupled to a respective page.

4. The scrapbook as in claim 2, wherein respective first layers of said respective insert sleeves are constructed of a generally transparent material so that articles situated in said interior area of said respective insert sleeves are visible from outside said respective insert sleeves.

5. The scrapbook as in claim 2, wherein said respective insert sleeves are coupled to said upper surfaces of respective pages.

6. The scrapbook as in claim 5, wherein said respective insert sleeves are coupled to said lower surfaces of respective pages.

7. The scrapbook as in claim 1, wherein a subset of said plurality of insert sleeves may be positioned on a respective single page such that no two of said subset of said plurality of insert sleeves contact one another.

8. The scrapbook as in claim 7, wherein said subset of said plurality of insert sleeves covers substantially less than an entirety of said respective single page.

9. The scrapbook as in claim 1, wherein a single insert sleeve is coupled to a respective page and covers substantially an entire surface area of said respective page.

10. The scrapbook as in claim 1, wherein said binding member includes a 2-ring binder system from which pages may be selectively added or removed.

11. A scrapbook for use in removably holding and displaying photographs and other personal artifacts, comprising:
a plurality of pages arranged in a stacked configuration, each page having opposed upper and lower surfaces in a generally planar configuration and a side edge;
a binding member coupled to respective side edges of said plurality of pages that is configured to maintain said plurality of pages in said stacked configuration; and
a plurality of insert sleeves coupled to selected upper surfaces of said plurality of pages, each said insert sleeve defining an interior area and having an opening configured to receive a photograph into said interior area.

12. The scrapbook as in claim 11, wherein each of said plurality of insert sleeves includes:
a first layer of plastic material having a generally rectangular configuration; and
a second layer of plastic material having a generally rectangular configuration and overlaying said first layer, said first and second layers being coupled on three of four side edges so as to define said interior area and said opening configured to receive a photograph into said interior area.

13. The scrapbook as in claim 12, wherein said first layer of a respective insert sleeve includes a bottom surface adhesively coupled to a respective page.

14. The scrapbook as in claim 12, wherein respective first layers of said respective insert sleeves are constructed of a generally transparent material so that articles situated in said interior area of said respective insert sleeves are visible from outside said respective insert sleeves.

15. The scrapbook as in claim 11, wherein a subset of said plurality of insert sleeves may be positioned on a respective single page such that no two of said subset of said plurality of insert sleeves contact one another.

16. The scrapbook as in claim 15, wherein said subset of said plurality of insert sleeves covers substantially less than an entirety of said respective single page.

17. The scrapbook as in claim 15, wherein a single insert sleeve is coupled to a respective page and covers substantially an entire surface area of said respective page.

18. The scrapbook as in claim 11, wherein said binding member includes a 2-ring binder system from which pages may be selectively added or removed.
